(19) United States
(12) Patent Application Publication
(10) Pub. No.: US 2024/0182284 A1
(43) Pub. Date: Jun. 6, 2024

(54) METHOD FOR CONTROLLING A DRIVE UNIT FOR A PREFERABLY DRIVERLESS TRANSPORT UNIT, DRIVE UNIT, AND TRANSPORT UNIT FOR SAME

(71) Applicant: Agilox Systems GmbH, Neukirchen bei Lambach (AT)

(72) Inventors: Manuel PERSTLING, Steinhaus (AT); Thomas WAKOLBINGER, Laakirchen (AT); Daniel ZINDL, Marchtrenk (AT)

(73) Assignee: Agilox Systems GmbH, Neukirchen bei Lambach (AT)

(21) Appl. No.: 18/556,547

(22) PCT Filed: Apr. 1, 2022
(86) PCT No.: PCT/AT2022/060101

§ 371 Date: Oct. 20, 2023

(30) Foreign Application Priority Data
Apr. 22, 2021 (AT) A50297/2021

(51) Int. Cl. B66F 9/06; B66F 9/075; B66F 17/00

(52) U.S. Cl. CPC B66F 9/063; B66F 9/07513; B66F 17/003

(57) ABSTRACT

A driverless transport unit, travel unit, and method for controlling a travel unit for a transport unit, in which a control signal for activating a travel unit is emitted by a controller in the transport unit, whereupon one or several electric motors of the travel unit are activated for driving wheels and the transport unit is moved forwards or backwards. The driving operation is monitored by a safety control/controller. Upon detection of a malfunction, in which driving operation of the travel unit or transport unit is continued on the basis of an emitted stop signal, or upon interruption of the energy supply, at least one blocking device is activated in the travel unit for stopping the travel unit or transport unit, respectively, wherein at least one gear, at least one gear wheel or directly at least one wheel is blocked via the blocking device.

The present invention relates to a method for controlling a travel unit for a preferably driverless transport unit, a travel unit for a preferably driverless transport unit and a transport unit, as described in claims 1, 6 and 11.

These days, usually driverless transport units are used to automatically transport, pick up, and deposit pallets. Here, the transport unit has an essentially U-shaped chassis with two legs, whereby two travel units are arranged on each of the legs, of which at least one travel unit is designed to be steerable. Such transport units are known, for example, from AT 509 305 A1 and GB 820 228 B.

Here, the travel units for the transport unit are formed by a wheel carrier, on which a wheel is preferably arranged on each of two opposite outer sides, whereby each wheel is connected via a gear wheel to respective one electric motor arranged in the interior of the wheel carrier, as disclosed in WO 2018/136987 A1.

The objective of the present invention is to create a method, a travel unit, and a transport unit, whereby safe operation is ensured.

This objective is achieved by the invention.

The objective is achieved by a method for controlling a travel unit for a preferably driverless transport unit, in which, when a malfunction is detected in which the driving operation of the travel unit 2 or of the transport unit 1, respectively, is continued on the basis of an emitted stop signal, or when the energy supply is interrupted, at least one blocking device 13 is activated in the travel unit 2 for stopping the travel unit 2 or the transport unit 1, whereby at least one transmission or at least one gear wheel 16 or directly at least one wheel 15 is blocked or locked, respectively, via the blocking device 13.

Here it is advantageous that this ensures that in the event of a malfunction or failure of the energy supply the transport unit stops immediately and thus cannot roll uncontrollably against shelves or objects, as the rotational movement of the wheels is blocked by the blocking device, i.e. an additional mechanical blocking device which engages in the event of a malfunction of the motor control or an interruption of the energy supply blocks the gear wheels in the travel unit and consequently the drive wheels or wheels, respectively, and thus brings the vehicle, in particular the transport unit, to an immediate standstill. Preferably, two brake pins are installed in each drive unit so that both motors of the drive unit can be blocked.

Control is advantageously carried out via the safety control, whereby the safety control detects that the stop of the transport unit is not carried out despite the stop request, so the voltage on the blocking device is removed or interrupted, respectively, whereby the brake is triggered and the gear wheels are blocked. It can thus be said that activating the blocking device interrupts the power or voltage supply, respectively, which returns the brake pin to the resting position, thus blocking the gears and, subsequently, the drive wheels as well.

Thus, it is necessary for the driving operation of the transport unit that the blocking device is activated, i.e. energized, whereby the brake pin is moved against a spring force into an operating position so that the wheels, in particular the gear wheel, can rotate freely.

For example, it is possible that the energy supply of the vehicle control system is suddenly interrupted and no intrinsically secure position of the travel units can be assumed, whereby the vehicle starts to roll uncontrollably, i.e. the transport unit is, for example, standing straight uphill or downhill, so that without a corresponding braking device it will start or continue to roll on its own and may thus collide with objects in an uncontrolled manner.

From the prior art, braking systems are known which, due to spatial constraints, do not act on the wheels of such transport units, but on the floor, so that it can happen that these cannot make contact and thus the transport unit is not braked or often braked too late, which is not the case with the solution according to the present invention, however, as this is integrated directly in the travel unit and thus acts directly on the gear wheels or the wheels, respectively, and thus block them.

Advantageous embodiments are such in which the blocking device is supplied with energy during travel. This ensures that in the event of a power failure, the brakes, in particular the brake pins, are automatically pushed back into the resting position due to the acting spring force, which causes the wheel to lock. This eliminates the need to use monitoring of the energy supply for the blocking device, as wheel blocking will always occur whenever the energy supply is terminated.

However, advantageous measures are also such in which the blocking device is formed by an electromagnetic brake pin, whereby the brake pin engages with the wheel of the travel unit or a gear wheel or transmission for the wheel of the travel unit whenever the blocking device is activated, in particular when there is no energy being supplied. This ensures that a cost-effective solution can be used with minimal space requirement in the drive unit.

Advantageous embodiments are such in which a separate blocking device is coupled or used, respectively, with each electric motor of the travel unit. This ensures that a very high level of safety is achieved. Concomitantly, all driven wheels are automatically locked via the brake pin when the energy supply ceases.

The objective of the present invention is furthermore solved by a travel unit for a preferably driverless transport unit, in which at least one gear wheel or gear or wheel directly driven by an electric motor is directly assigned at least one blocking device, which is designed in such a way that in the event of a malfunction or interruption of the energy supply, the blocking device is activated, so that at least one gear or at least one gear wheel, respectively, or directly at least one wheel is locked or blocked, respectively, via the blocking device.

It is advantageous here that through the use of a blocking device, which preferably acts directly on the gear or a gear wheel forming the gear, respectively, the travel unit and thus also the transport unit can no longer begin to roll independently, or the rolling movement can be stopped safely, respectively.

Normally, the drive units are controlled in such a way that they cross each other out and thus serve as holding brakes. However, if a fault occurs in the drive controllers, e.g. overload or power failure, the drive units can no longer be aligned crosswise to each other, so the blocking device starts to act. This increases operational safety, as a safe stop is made not only in the event of a fault, but also whenever the transport unit runs out of power. This can happen, for example, if the planned transport path of the transport unit is obstructed by objects and the transport unit thus has to take a detour to the charging station, so that the energy can run out due to the extended path.

In an advantageous embodiment, the blocking device is formed by an electromagnetic brake pin arranged in a defined position via a spring element in the rest state, i.e. without energy supply. This achieves a very small design, so the locking device can be installed directly into the wheel carrier. This creates a complete travel unit, into which a safety system is also integrated, which locks the wheels or gears, respectively, when not in use.

In an advantageous embodiment, the blocking device is connected to its own energy supply or via the energy supply of the electric motors. This allows for appropriate control depending on the required control. Preferably, the blocking device is coupled to the electric circuit or power circuit, respectively, of the electric motors, so that when the latter are activated, the blocking device is concomitantly also energized, without additional start signals, so that the brake pin is thereby pulled from its resting position, in which it blocks the associated gear or directly the wheel, into a working position, thereby releasing the gear or the wheel.

If, on the other hand, a separate circuit is used for the blocking device, the blocking device must be activated simultaneously with the start of the electric motors so that the brake pin releases the gear or wheel, as otherwise the electric motor cannot drive the gear wheel.

Advantageous embodiments are such in which the blocking device is arranged within the wheel carrier, preferably parallel to the electric motors. This results in a compact assembly. Thus, the travel unit including the blocking device can be integrated into the leg of a transport unit, so that an unintentional movement of the transport unit is prevented by the blocking of the wheels or gear wheels, respectively, of the travel units used.

In an advantageous embodiment, the blocking device, in particular the brake pin, engages when activated or is arranged between two teeth of the gear wheel or in an elongated hole of the gear wheel 16 or on the surface of the gear wheel 16 or directly on the wheel 15. This ensures that the gear wheel that is directly connected to the wheel or driving wheel, respectively, is blocked.

However, the objective of the invention is also achieved by a driverless transport unit for automatically conveying, picking up and delivering pallets, in which at least one travel unit has at least one mechanical blocking device that is designed in such a way that, in the event of a malfunction or interruption in the energy supply, this is activated, so that at least one gear or at least one gear wheel, respectively, 16 or directly at least one wheel 15 is blocked or locked, respectively, via the blocking device 13.

It is advantageous here that unintentional movement of the transport unit is prevented by blocking at least one gear wheel of a drive unit. Preferably, however, all travel units used are equipped with a corresponding blocking device so that each driven wheel can be blocked with its own blocking device.

Advantageous embodiments are such in which the safety control or the controller is designed to interrupt the energy supply for the blocking device. Thus, monitoring of the systems is achieved independently of the usual control.

It is advantageous to have a design in which the blocking device is deactivated for a driving operation. This ensures that in the event of power failure, the brake pin automatically blocks the gear wheel or directly the wheel, thus preventing uncontrolled movement of the transport unit.

Finally, it is advantageous to have an embodiment in which the controller 8 and/or safety control 10 is connected to an encoder of the electric motor 14 for monitoring the driving operation of the travel unit 2. Evaluation or monitoring of the encoder ensures that a rolling movement of the travel unit or the transport unit, respectively, can be easily detected, since the wheels transmit with the electric motor, preferably with the interposition of the gear wheels or gears, respectively, so that a signal is transmitted to the control or safety control due to the rotary movement of the electric motor. This allows them to detect that the transport unit is moving, so the blocking device can be activated to stop this movement.

It is also possible that during driving operation, the rotational movement or speed, respectively, is measured first before the blocking device is activated, in order to avoid the destruction of the brake pin if the speed is too high. If the speed is too high, here a normal braking process with a braking ramp can be initiated first, so that the blocking device is activated when a defined speed is reached. If, however, the braking process takes too long, the safety control system issues the message “Imminent Danger” so that the blocking device is activated despite the high speed.

The invention is further explained by means of the exemplary embodiments shown in the drawings, wherein, however, the invention is not limited to these exemplary embodiments.

The figures show:

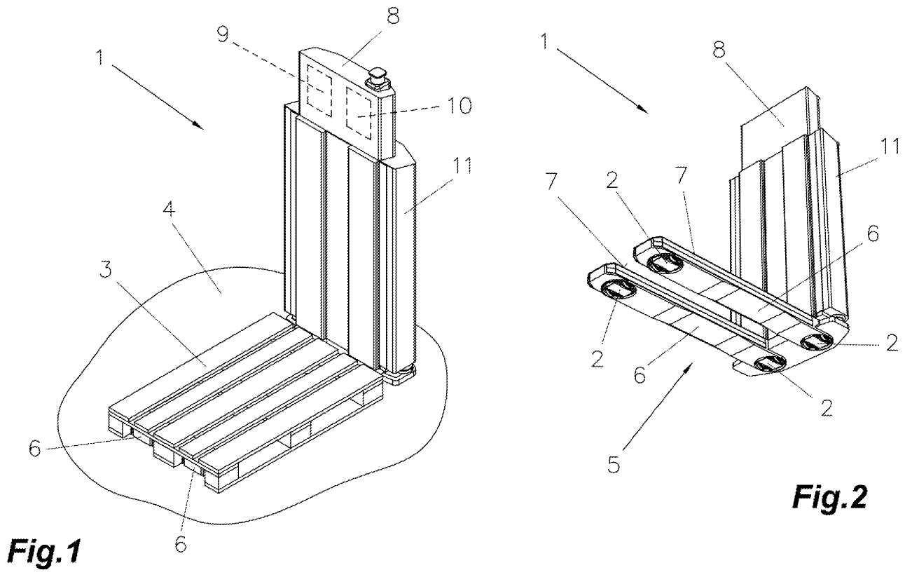

FIG. 1 a schematic representation of a driverless transport unit with a pallet picked up—simplified, for illustrative purposes only;

FIG. 2 a schematic bottom view of the driverless transport unit according to FIG. 1—simplified, for illustrative purposes only;

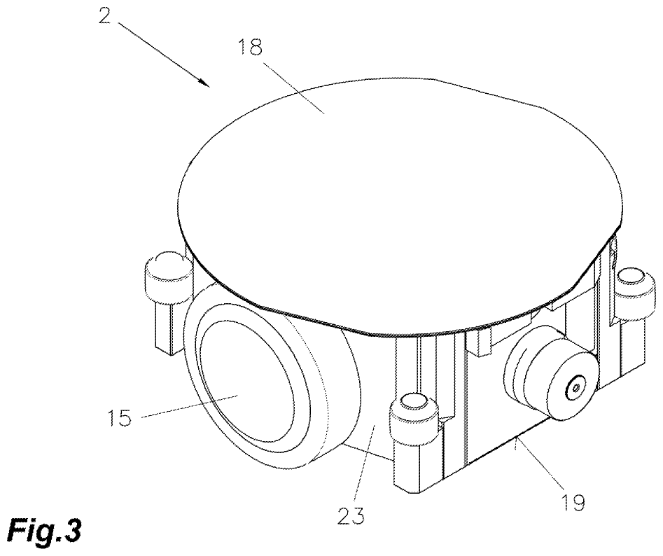

FIG. 3 a schematic representation of the travel unit for integration in the driverless transport unit according to FIGS. 1 and 2—simplified, for illustrative purposes only;

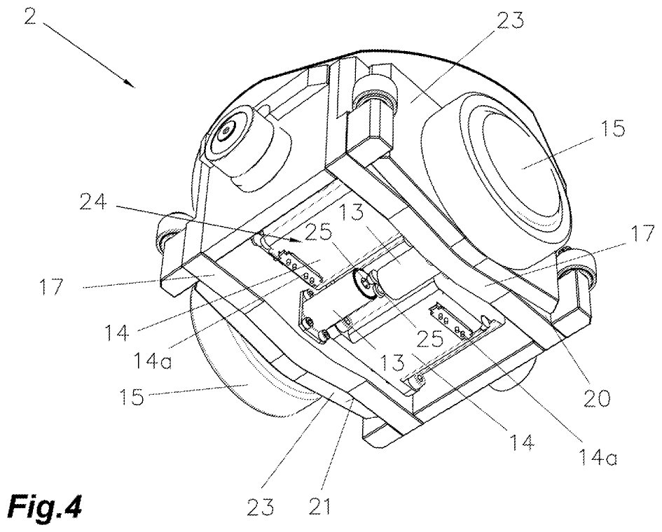

FIG. 4 a schematic bottom view of the travel unit with removed floor element and activated blocking device for releasing the gear wheels according to FIG. 4—simplified, for illustrative purposes only;

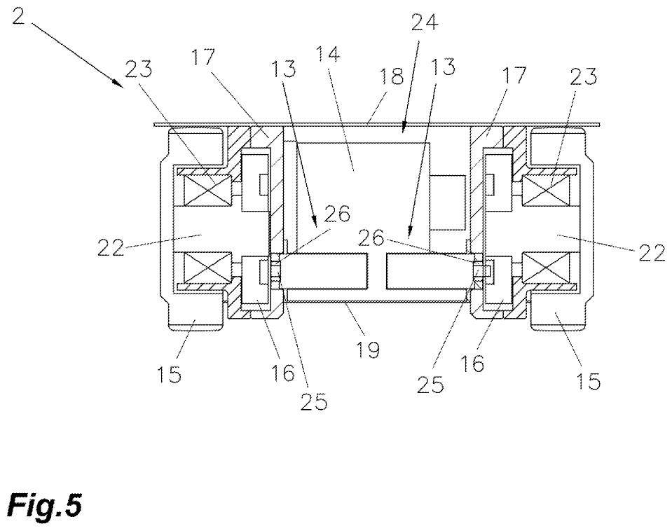

FIG. 5 a sectional view of the travel unit with deactivated blocking device for releasing the gear wheels according to FIG. 4—simplified, for illustrative purposes only.

It should be stated by way of introduction that, in the individual embodiments, identical parts are provided with the same reference numbers or same component designations, respectively, wherein the disclosures contained in the entire description can, by analogy, be transferred to identical parts with identical reference numbers or identical component designations, respectively. The position details selected in the description, such as, e.g., top, bottom, lateral, etc., likewise relate to the figure described, and in the event of a change of position, they are to be transferred to the new position by analogy. Individual features or feature combinations from the exemplary embodiments shown and described may also represent independent inventive solutions.

In FIGS. 1 to 5, a preferably driverless transport unit 1 with integrated travel unit 2 is shown, whereby a method for controlling the travel unit 2 for the preferably driverless transport unit 1 is carried out. The travel unit 2 is preferably designed as an independent assembly which is installed or used, respectively, in the transport unit 1.

The driverless transport unit 1 is used for automatically picking up and delivering pallets 3 and for moving the pallets 3 from any first point to any second point without the need for an additional device on the floor 4, as described for example in AT 509 305 A1, so that the detailed design of the transport unit 1 will not be discussed any further. The transport unit 1 has an essentially U-shaped chassis 5 with two legs 6, on which a lifting fork 7 is arranged so as to be vertically movable. In the area of the corners of the chassis 5, the travel units 2 are integrated into the leg 6. On the U-shaped chassis 5, a controller 8 is arranged at one end, in particular at the end where the two legs 6 are connected, into which all controls 9 for driving operation and a safety control 10 for monitoring are integrated. Here it is possible that a casing 11 is arranged on the control unit 8.

As disclosed in AT 509 305 A1 or other similar transport units 1 from the prior art, the transport unit 1 has corresponding sensors 12 for picking up a pallet 3 or for pathfinding during driverless driving operation.

According to the present invention, it is now envisioned to substantially increase the driving safety of a transport unit 1, whereby a new travel unit 2 according to the present invention is used. Here, the new travel unit 2 has a blocking device 13 whereby the wheels 15 driven by electric motors 14 can be safely blocked. Preferably, two wheels 15 with two electric motors 14 are arranged in a travel unit 2, whereby each wheel 15 is driven by one electric motor 14 via a gear wheel 16, i.e. the electric motor 14, in particular its shaft, is connected to a smaller gear wheel (not shown) which drives a larger gear wheel 14, thus forming a so-called transmission or gear, respectively. Here, the travel unit 2 is designed as an assembly in which all elements for driving the wheels 15, thus including the blocking device 13, are arranged and the travel unit 2 is connected only via an energy supply and control lines (not shown) to external components, in particular the controller 9 and/or safety control unit 10, for which corresponding plug connections 14a are integrated. Preferably, a single cable harness is routed to the encoder of the electric motor 14, whereby the speed of the electric motor 14 is determined via the encoder. Two strands are split off from the cable harness for the blocking device 13 in order to supply the blocking device 13 with power. Thus, the entire assembly can be installed in a transport unit 1 or other units and can also be exchanged. A similar structure and functional description are disclosed in WO 2018/136987 A1, so this will not be discussed in detail here.

As disclosed in WO 2018/136987 A1, the travel unit 2 designed as an assembly, as shown in FIGS. 3 to 5, comprises at least one wheel carrier 17 with preferably a top and bottom element 18, 19, wherein a wheel 15 is arranged on each of preferably two opposite outer sides 20, 21 of the wheel carrier 17. Each wheel 15 is connected via a gear wheel 16 to a respective electric motor 14 arranged in the wheel carrier 17. Here, the electric motor 14, to whose shaft preferably also a gear wheel (not shown) is attached, is connected or coupled, respectively, to the gear wheel 16, whereby the gear wheel 16 is attached to a drive shaft 22, to which the wheel 15 is preferably connected via a wheel bearing 23.

The blocking device 13 is arranged in the interior space 24 of the wheel carrier 17, whereby a separate blocking device 13, which is preferably aligned parallel to the electric motor 14, is preferably provided for each drive, i.e. each electric motor 14. Here, the blocking device 13 is provided by an electromagnetic brake pin 25 which engages with the gear wheel 16 through an opening or hole, respectively, 26 in the wheel carrier 17 to block the driving operation, in particular the gear wheel 16. The brake pin 25 is referred to e.g. as “PinBrake”, which in the resting position, i.e. without energy supply, moves via a spring element (not shown) into a defined position, in particular into the blocking position, as shown in FIG. 5. Here the blocking device 13 is designed in such a way that without energy supply the brake pin 25 engages in the gear wheel 14 and thus blocks it. Only when the blocking device 13 is energized, as shown in FIG. 4, is the brake pin 25 pulled in the direction of the interior space 24, whereby this releases the gear wheel 14 and thus enables driving operation of the travel unit 2 or the transport unit 1, respectively. This means that for the driving operation the locking device 13 must be energized so that the brake pin is moved from its resting position to an activation position, whereby it releases the gear 16 to drive the wheels 15 by the electric motors 14. If an irregularity occurs or is detected by the safety control 10 due to a hazardous situation, which is detected by sensors arranged accordingly on the transport unit 1, in particular the encoder, the blocking device is activated so that the energy supply from the blocking device 13 is interrupted, whereupon, due to the built-in return spring, the brake pin 25 is moved back into the resting position and thus the gear wheel 16 is blocked by the brake pin being inserted between two teeth of the gear wheel 25. It is of course possible that instead of engaging between two teeth of the gear 16, the locking device 13 may also act directly on the wheels 15, for which purpose corresponding holes or projections are provided on the inner end walls in which the brake pin 15 may engage, or in an elongated hole on the gear 25, several of which are arranged in the periphery. It is essential that, when the blocking device 13 is activated, the rolling movement of the transport unit 1 is blocked by blocking the gear wheels 16 or the wheels 15, so that the transport unit 1 is abruptly stopped.

It can thus be said that the solution according to the present invention includes a method for controlling a travel unit 2 for a preferably driverless transport unit 1, in which a control signal is emitted by a control unit 9 in the transport unit 1 to activate the travel units 2 used, whereupon one or several electric motors 14 of the travel units 2 are activated to drive wheels 15 and the transport unit 1 is moved forwards or backwards. The travel operation is preferably monitored by a safety controller (safety control 10), wherein, when a malfunction is detected in which the driving operation of the travel unit 2 or of the transport unit 1, respectively, is continued on the basis of an emitted stop signal, or when the energy supply is interrupted, a blocking device 13 is activated in the travel unit 2 for stopping the travel unit 2 or the transport unit 1, respectively. Basically, it should be mentioned that the safety control 10 can also be integrated into the controller 9.

Thanks to the straightforward integration of the blocking device 13 into the interior space 24 of the wheel carrier 17, it is possible that previously inserted travel units 2 of this type can be replaced by the new travel unit 2 without great effort, as the size remains the same.

In this case, it is also possible to have an embodiment in which only a single locking device 13 is used for the travel unit 2 with two wheels 15, so that only one wheel 15 is locked when the locking device 13 is activated. Furthermore, the blocking device 13 can be designed in such a way that there is a brake pin 25 on both sides, which is pulled into the housing of the blocking device 13 when the blocking device 13 is supplied with energy, i.e. when the brake pin 25 is deactivated, thus releasing both sides. This allows a locking device 13 to be used for both wheels 15 when positioned so that the brake pins 25 can engage both gears 16.

A main problem with such driverless transport units 1 is the safe stop in case of a malfunction or if the energy supply runs out and the transport unit 1 cannot return to the charging station in time, as this often causes the transport units 1 to come to a standstill at an arbitrary point. If in such a situation the ground is uneven, without the blocking device 13 the transport unit 1 may start to roll. Since the blocking device 13 is designed in such a way that it releases the blocking of the gears 16 only upon energy supply, such a case can be easily prevented with the solution according to the present invention.

It also often happens that the transport unit 1 stands on uneven ground and the travel operation is stopped by the controller 9, whereby the energy supply to the electric motors ceases, but the transport unit 1 can still start to roll, so that this is also prevented when using the novel travel unit 1 with the blocking device 13. Such rolling can be detected by the safety control 10 and/or the controller 9 via the encoder of the electric motors 14, since there should be no rotary movement, in particular speed or rotational speed, of the electric motors 14 during a stop.

By using its own safety controller 10, i.e. the safety control 10, the driving operation of the transport unit 1 is additionally monitored so that, for example, if a malfunction is detected in which the driving operation of the travel unit (2) or the transport unit (1) is continued on the basis of an emitted stop signal, this is detected so that the blocking device is deactivated and the energy supply to the blocking device 13 is interrupted. This can be achieved simply by controlling an interrupting element (not shown), in particular by controlling a relay or switching element integrated in the power circuit of the blocking device 13, so that very fast and simple deactivation of the blocking device 13 is given. Of course, the blocking device 13 can also be supplied via its own electric circuit or power circuit, respectively, in which a breaker, in particular a relay or switching element, is integrated via which the safety control 10 can interrupt the circuit.

It is also possible that the blocking device 13 is integrated into the energy circuit of the electric motors 14, so that when the electric motors 14 are activated for driving, the blocking device 13 is automatically supplied with energy and thus the brake pins release the gears 14. If the interruption occurs due to a malfunction or an abrupt stop of the transport unit 1, an interrupter is activated in turn. Of course, the interrupting element can also be designed in such a way that it has to be deactivated for triggering, in particular for terminating the energy supply to the blocking device 13, i.e. that the interrupting element is activated for driving operation and the interrupting element is deactivated for terminating the energy supply.

Usually, the transport unit 1 is slowed down by a stop ramp, which continuously reduces the speed until it comes to a standstill. For example, if an emergency occurs and the transport unit 1 must be stopped abruptly, the blocking device 13 is activated so that the brake pins 25 engage between two teeth of the gear wheel 16, and the rotary movement stops immediately.

It is also possible for the blocking device 13 to be used as a parking brake, in that after the transport unit 1 has been properly braked down over a predetermined stop ramp, the transport unit 1 comes to a standstill. The blocking device 13 is then activated so that the brake pin blocks the gear wheel 16 or directly the wheel 15, depending on the embodiment. Before the transport unit 1 resumes driving, the locking device 13 is deactivated so that it releases the gear wheel 16 or wheel 15.

It is further envisioned that a check of the blocking device 13 is also carried out by the controller 9 or the safety control unit 10 before the travel operation by activating the blocking device 13 and slowly starting the transport unit 1. If the blocking device 13 is in order, the movement of the transport unit 1 is blocked, which can be determined via the encoder, in which it does not supply any speed or speed, although a travel mode is activated. Such a check can be carried out before each driving operation or at cyclical intervals.

Basically, when the blocking device 13 is activated, it means that the energy supply to the blocking device 13 is interrupted so that the brake pin 25 is extended into the resting position, i.e. blockade position. Conversely, deactivation of the blocking device 13 means the supply of energy to the blocking device 13 whereby the brake pin 25 is retracted and thus driving operation made possible.

According to the present invention, a method for controlling a travel unit 2 for a preferably driverless transport unit 1 is envisioned, in which a control signal for activating a travel unit 2 is emitted by a controller 8 in the transport unit 1, whereupon one or several electric motors 14 of the travel unit 2 are activated for driving wheels and the transport unit 1 is moved forwards or backwards, wherein the driving operation is preferably monitored by a safety control 10 (safety controller 10), whereby upon detection of a malfunction, in which the driving operation of the travel unit 2 or of the transport unit 1 is continued on the basis of an emitted stop signal, or upon interruption of the energy supply, at least one blocking device 13 is activated in the travel unit 2 for stopping the travel unit 2 or the transport unit 1, respectively, wherein at least one gear or at least one gear wheel 16 or directly at least one wheel is blocked or locked via the blocking device 13.

It is pointed out that the invention is not limited to the embodiments shown, but may comprise further embodiments. In particular, the embodiments or individual features of the embodiments can also be combined with each other.

1. A method for controlling a travel unit for a preferably driverless transport unit, in which a control signal for activating a travel unit is emitted by a controller in the transport unit, whereupon one or several electric motors of the travel unit are activated for driving wheels and the transport unit is moved forwards or backwards, wherein the driving operation is preferably monitored by a safety control (safety controller), wherein upon detection of a malfunction, in which the driving operation of the travel unit or of the transport unit is continued on the basis of an emitted stop signal, or upon interruption of the energy supply, at least one blocking device is activated in the travel unit for stopping the travel unit or the transport unit, respectively, wherein at least one gear or at least one gear wheel or directly at least one wheel is blocked or locked via the blocking device.

2. The method according to claim 1, wherein the blocking device is supplied with energy during the driving operation.

3. The method according to claim 1, wherein the blocking device is formed by an electromagnetic brake pin, whereby the brake pin engages with the wheel of the travel unit or a gear wheel or gear for the wheel of the travel unit, respectively, when the blocking device is activated, in particular when there is no power being supplied.

4. The method according to claim 1, wherein a separate blocking device is coupled or used with, respectively, each electric motor of the travel unit.

5. The method according to claim 1, wherein the travel unit, which comprises at least one wheel carrier on which, preferably on two opposite outer sides, in each case one wheel is arranged, wherein each wheel is connected via a gear wheel to in each case one electric motor, is formed so that each wheel is connected via a gear wheel to in each case one electric motor, wherein at least one gear wheel or gear or wheel, which is driven by an electric motor, respectively, is directly assigned at least one blocking device which is designed in such a way that, in the case of a malfunction or interruption in the energy supply, the blocking device is activated, so that at least one gear or at least one gear wheel or directly at least one wheel is blocked or locked, respectively, via the blocking device, and the transport unit, which comprises a chassis that is essentially U-shaped in plan view and has two legs, is formed so that at least two travel units are arranged on each leg of the chassis, of which at least one travel unit can be steered, whereby the travel unit, in particular the electric motors, is connected to a control system for the driving operation and/or a safety control system or safety control for monitoring the driving operation, wherein at least one travel unit has at least one mechanical blocking device which is designed in such a way that, in the event of a malfunction or in the event of an interruption in the energy supply, the same is activated, so that at least one gear or at least one gear wheel or directly at least one wheel, respectively, is blocked or locked, respectively, via the blocking device.

6. A travel unit for a preferably driverless transport unit, comprising at least one wheel carrier on which, preferably on two opposite outer sides, in each case one wheel is arranged, wherein each wheel is connected via a gear wheel to in each case one electric motor, wherein at least one gear wheel or gear or wheel which is driven by an electric motor, respectively, is directly assigned at least one blocking device which is designed in such a way that, in the case of a malfunction or interruption in the energy supply, the blocking device is activated, so that at least one gear or at least one gear wheel or directly at least one wheel is blocked or locked, respectively, via the blocking device.

7. The travel unit according to claim 6, wherein the blocking device is formed by an electromagnetic brake pin which, in the rest state, i.e. without energy supply, is arranged in a defined position via a spring element.

8. A travel unit according to claim 6, wherein the blocking device is connected to its own energy supply or via the energy supply of the electric motors.

9. A travel unit according to claim 6, wherein the blocking device is arranged within the wheel carrier, preferably parallel to the electric motors.

10. A travel unit according to claim 6, wherein the locking device, in particular the brake pin, engages or is arranged, when activated, between two teeth of the gear wheel or in an elongated hole of the gear wheel or on the surface of the gear wheel or directly on the wheel, respectively.

11. A driverless transport unit for automatically conveying, picking up and delivering pallets, having a chassis that is essentially U-shaped in plan view and has two legs, wherein at least two travel units are arranged on each leg of the chassis, of which at least one travel unit can be steered, whereby the travel unit, in particular the electric motors, is connected to a control system for the driving operation and/or a safety control system or safety control for monitoring the driving operation, wherein at least one travel unit has at least one mechanical blocking device which is designed in such a way that, in the event of a malfunction or in the event of an interruption in the energy supply, the same is activated, so that at least one gear or at least one gear wheel or directly at least one wheel, respectively, is blocked or locked, respectively, via the blocking device.

12. A transport unit according to claim 11, wherein the safety control or the controller is designed so as to interrupt the energy supply for the blocking device.

13. The transport unit according to claim 11, wherein the blocking device is deactivated for driving operation.

14. The transport unit according to claim 11, wherein the control and/or safety control is connected to an encoder of the electric motor for monitoring the driving operation of the travel unit.
